(19) United States
(12) Patent Application Publication
(10) Pub. No.: US 2005/0265206 A1
(43) Pub. Date: Dec. 1, 2005

(54) Optical disc reproducing device and optical disc reproducing method

(75) Inventor: Takahiro Yamamoto, Fuchu-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 10/932,312

(22) Filed: Sep. 2, 2004

(30) Foreign Application Priority Data
May 31, 2004 (JP) P2004-162617

(51) Int. Cl. G11B 7/00; G11B 7/135

(52) U.S. Cl. 369/118; 369/44.37; 369/112.01; 369/44.24

(57) ABSTRACT

As an aperture diaphragm of an optical disc, the aperture diaphragm in which an aperture differs for a first and a second wavelength, and the aperture in a radial direction of the optical disc at the second wavelength is smaller than the aperture in a circumferential direction is used. By making the aperture in the radial direction small, a spot diameter of a beam is made larger, and thereby influence on a tracking error signal and the like due to variation in the optical disc in a perpendicular direction to a track is reduced. By making the aperture in the radial direction larger than the aperture in a tangential direction, reduction in an area of the aperture, in its turn, in the optical coupling efficiency can be restrained.

### CROSS-REFERENCE TO THE INVENTION

This application is based upon and claims the benefit of priority from the prior Japanese Patent Application No. 2004-162617, filed on Mar. 31, 2004; the entire contents of which are incorporated herein by reference.

### BACKGROUND OF THE INVENTION

1. Field of the Invention

This invention relates to an optical disc reproducing device and an optical disc reproducing method.

2. Description of the Related Art

In optical disc reproducing devices, there are the ones including a light source which emits light of plural wavelengths to make it possible to reproduce plural kinds of optical discs (optical recording media) such as a CD (Compact Disc) and a DVD (Digital Versatile Disc).

Here, an art of recording and reproducing different kinds of optical discs by using a two-wavelength semiconductor laser which emits laser light of different wavelengths from two light emitting points is opened to public (see Japanese Patent Laid-open Application No. 2004-5802).

### SUMMARY OF THE INVENTION

When both of a CD and a DVD are to be recorded and reproduced in an optical disc device using a two-wavelength semiconductor laser, each laser light for the CD and for the DVD takes approximately the same optical path, and a collimator lens and an objective lens are used in common. As a result, the optical magnifying powers are substantially equal in both the optical systems for the CD and the DVD.

Therefore, it is difficult to ensure the performances in both the CD and DVD. For example, when the optical system is designed not to degrade the performance in the DVD, this optical system becomes too high in the optical magnifying power for CD. Namely, since the spot diameter of the laser light on the CD becomes small and the resolution becomes too high, the allowable range for the variation of the optical disc is narrowed.

As the countermeasures against this, it is considered to change the aperture of the aperture diaphragm in accordance with the CD and the DVD and make the numerical aperture NA for the CD smaller than the numerical aperture NA for the DVD. In doing so, the spot diameter of the laser light on the CD becomes large, and the allowable range for the variation of the optical disc can be widened.

However, reduction in the numerical aperture NA means increase in the loss of light, and causes the reduction in the optical coupling efficiency.

In view of the above, this invention has its object to provide an optical disc reproducing device and an optical disc reproducing method which are intended to make adjustment of the spot diameter compatible with sustainment of the optical coupling efficiency.

An optical disc reproducing device according to the present invention includes a first light source configured to emit first laser light, a second light source configured to emit second laser light of which wavelength is longer than the first laser light, an objective lens configured to condense the laser light emitted from the aforesaid first and second light sources onto an optical disc, and an aperture diaphragm disposed between the aforesaid first and second light sources and the aforesaid objective lens, in which an aperture differs for the first and second wavelengths, and the aperture in the radial direction of the optical disc at the second wavelength is smaller than the aperture in a tangential direction.

As the aperture diaphragm of the optical disc, the aperture diaphragm, in which the aperture differs for the first and the second wavelengths, and the aperture in the radial direction of the optical disc is smaller than the aperture in the circumferential direction at the second wavelength, is used. By making the aperture in the radial direction smaller than in the circumferential direction, a spot diameter of a beam in the radial direction is made large, and the influence on a tracking error signal and the like due to variation in the optical disc in the perpendicular direction to a track can be reduced. By making the aperture in the radial direction larger than the aperture in the tangential direction, reduction in the area of the aperture, which ultimately leads to reduction in the optical coupling efficiency, can be suppressed.

### BRIEF DESCRIPTION OF THE DRAWINGS

FIG. 1 is a schematic view showing an optical disc reproducing device according to one embodiment of the present invention.

FIGS. 2A and 2B are schematic views each showing an example of an aperture of an aperture diaphragm in a first and a second wavelengths.

FIG. 3A is a top view showing a beam spot of laser light of the second wavelength, which is formed on an optical disc.

FIG. 3B is an enlarged top view showing the beam spot shown in FIG. 3A by enlarging it.

FIG. 4 is a schematic view showing a constitution example of an aperture diaphragm.

FIGS. 5A to 5C are views showing examples of the intensity distribution of the light of the beam spot by the contour lines (more accurately, the isointensity lines).

FIG. 6 is a graph showing an example of correspondence of a skew of the optical disc and jitter.

### DESCRIPTION OF THE EMBODIMENTS

Hereinafter, an embodiment of the present invention will be described in detail with reference to the drawings.

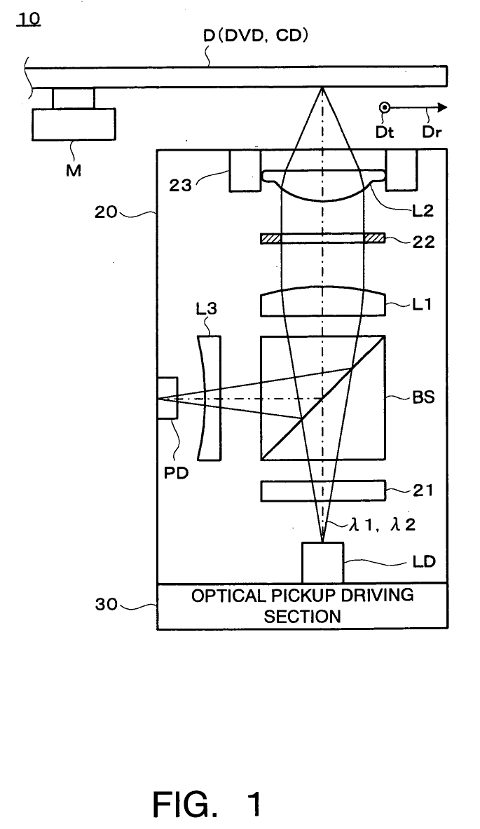

FIG. 1 is a schematic view showing an optical disc reproducing device 10 according to one embodiment of the present invention.

The optical disc reproducing device 10 includes an optical pickup 20 and an optical pickup driving section 30, and reads information from plural optical discs D (DVD (Digital Versatile Disc), CD (Compact Disc) and the like) of different specifications.

The optical disc D is rotated by a disc motor M. This is for the purpose of recording and reproducing the information along a track of the optical disc D.

The optical disc D has a concentric or a spiral track, and information is recorded and reproduced on this track. The direction approximately perpendicular to the track is a radial direction Dr of the optical disc D, and the tangential direction of the track is a tangential direction (circumferential direction) Dt of the optical disc D.

The optical pickup 20 has a laser diode LD, a grating 21, a beam splitter BS, a collimator lens L1, an aperture diaphragm 22, an objective lens L2, an actuator 23, a detecting lens L3 and a photo diode PD, and reads the information from the optical disc D.

The optical pickup driving section 30 is an actuator for moving (seek or the like) the entire optical pickup 20.

The laser diode LD which is the laser light source emits first laser light of a first wavelength (λ1) and second laser light of a second wavelength (λ2), respectively. Namely, the laser diode. LD can be considered to be the unification of the first and second light sources which emit the laser light of different wavelengths, respectively. For example, the laser diode LD can be made by forming the first and second light sources on the single semiconductor chip. The light emission points of the first and the second laser light are as close to each other as about 100 μm, for example. As the examples of the first and the second wavelengths, the wavelength of 650 nm for reproduction of DVDs and the wavelength of 780 nm for reproduction of CDs can be cited.

The grating 21 is a diffraction grating which diffracts first and second light incident thereon. The first and the second laser light is diffracted by the grating 21 and divided into a main beam (zero-order diffracted light) and two sub beams (±primary diffracted light), which can be used for generation of a tracking error signal (differential push-pull signal: DPP signal).

The beam splitter BS is a light polarizing element which transmits the light in a predetermined polarized direction and reflects the light in the polarized direction perpendicular to the predetermined polarized direction. The beam splitter BS is set to transmit the first and the second laser light incident from the laser diode LD and reflect the first and the second laser light reflected at the optical disc D.

The collimator lens L1 is an optical element which converts the first and the second laser light emitted from the beam splitter BS into collimated light and converts the first and the second laser light reflected from the optical disc D into convergent light.

The aperture diaphragm (aperture stop) 22 is an optical element for narrowing down the beams of the first and the second laser light. The detail of this will be described later.

The objective lens L2 is an optical element for condensing the first and the second laser light onto the optical disc D, and converting the laser light reflected from the optical disc D into collimated light.

The actuator 23 moves the objective lens L2 in the longitudinal direction and the radial direction of the optical disc D, and performs focusing of the first and the second laser light, and adjustment of the spot position (tracking).

The detecting lens L3 is an optical element for condensing the first and the second laser light onto the photodiode PD.

The photodiode PD which is a light-receiving element is an element for detecting the first and the second laser light reflected at the optical disc D and reading out the information from the optical disc D.

Corresponding to the laser light being divided into the main beam and two sub beams by the grating 21, the photodiode PD has the detection region divided so as to be able to detect these three beams independently. The respective three beams are detected, and arithmetically operated, and thereby generation of the tracking error signal (differential push-pull signal: DPP signal) by the differential push-pull method (DPP method) is performed.

(Operation of the Optical Pickup 20)

The operation of the optical pickup 20 will be explained. Though only one of the first and the second laser light is usually emitted in accordance with the kind of the optical disc D, the explanation will be made by contrasting the first with the second laser light to make it easier to understand.

(1) The first and the second laser light emitted from the laser diode LD is divided into three beams by the grating 21.

The three beams are transmitted through the beam splitter BS, incident on the collimator lens L1, and converted into the collimated light.

(2) The first and the second laser light passes through the aperture diaphragm 22, are incident on the objective lens L2, and condensed on the optical disc D. For example, the first laser light is condensed on a DVD, and the second laser light is condensed on a CD. The shape and the spot diameter of the beam spot formed on the optical disc D are adjusted by the aperture diaphragm 22.

(3) The first and the second laser light reflected at the optical disc D passes through the objective lens L2 and the collimator lens L1 and are transmitted through the beam splitter BS.

(4) The first and the second laser light transmitted through the beam splitter BS passes through the detecting lens L3, and is incident on the photodiode PD. The signals corresponding to the three beams are outputted from the photodiode PD, the DPP signal is generated by arithmetically operating these three outputs, thus making it possible to perform a tracking control of the optical pickup 20.

(Details of the Aperture Diaphragm 22)

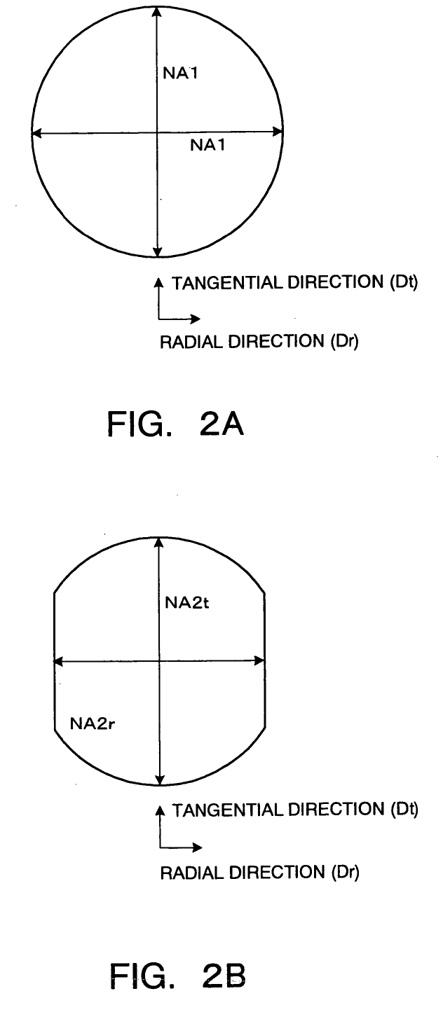

FIGS. 2A and 2B are schematic views showing the shapes of the aperture of the aperture diaphragm 22 corresponding to the first and the second wavelengths. The apertures of the aperture diaphragm 22 at the first and second wavelengths are different not only in numerical aperture but also in shape.

As understood from FIG. 2A, the aperture of the aperture diaphragm 22 with the first wavelength is a circular shape. Namely, the aperture diaphragm 22 has the equal numerical aperture NA1 (NA: Numerical Aperture) in each of the radial direction Dr and the tangential direction Dt of the optical disc D.

On the other hand, the aperture of the aperture diaphragm 22 with the second wavelength is a circular shape in the tangential direction Dt of the optical disc D, but in the radial direction Dr, the aperture becomes a linear shape perpendicular to the radial direction Dr, and the aperture is limited. Namely, the numerical aperture NA2r in the radial direction Dr of the optical disc D is smaller than the numerical aperture NA2r in the tangential direction Dt.

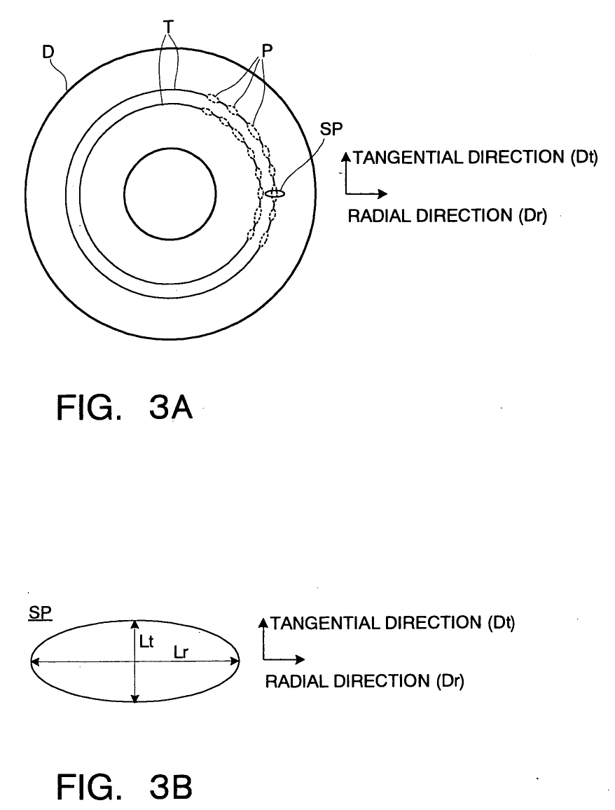

FIG. 3A is a top view showing the beam spot SP of the laser light of the second wavelength, which is formed on the optical disc D. FIG. 3B is an enlarged top view showing the beam spot SP shown in FIG. 3A by enlarging it. Pits P are disposed along the track T of the optical disc D. The position of the beam spot SP is controlled to correspond to the track T.

Reflecting the shape of the aperture of the aperture diaphragm 22, the diameter Lr of the beam spot SP in the direction across the track T of the optical disc D (radial direction Dr) is larger than the diameter Lt of the beam spot SP in the direction along the track T (tangential direction Dt).

The reason why the numerical aperture NA2r in the radial direction Dr is made smaller than the numerical aperture NA2r in the tangential direction Dt is as follows.

(1) In order to increase the optical coupling efficiency, namely, utilizing efficiency of the laser light emitted from the laser diode LD, it is more preferable that the numerical aperture NA is large.

(2) In order to widen the allowable range for the variation of the optical disc D (variation in the size of the pit to be recorded, warping of the optical disc D, and mechanical deviation at the time of loading), it is preferable to make the diameter L of the beam spot SP large to some degree. This is because the influence of the vibration in the size of the pit P on the tracking error signal becomes small by making the size of the beam spot SP large to some degree. To make the diameter L of the beam spot SP large means to make the numerical aperture NA small.

These conditions of (1) and (2) are seemingly incompatible. However, these are compatible when it is considered to change the numerical aperture of the aperture diaphragm 22 in the radial direction Dr and the tangential direction Dt.

(3) To ensure the optical coupling efficiency, an area of the aperture has to be ensured though it does not necessarily have to be the round aperture.

(4) Considering the influence of the aperture on the tracking error, it is suitable if only the spot diameter Lr is ensured in the direction perpendicular to the track, namely, in the diameter direction Dr. This means that the numerical aperture NAr is small in the radial direction Dr.

(5) Considering readout of the information from the track, it is preferable that the spot diameter Lt is smaller in the direction along the track, namely, in the tangential direction Dt. This means that the numerical aperture NAt is large in the tangential direction Dt.

As described above, considering (3) to (5), it is found out that by making the numerical aperture NA2r in the diameter direction Dr smaller than the numerical aperture NA2r in the tangential direction Dt, the allowable range for the variation of the optical disc D can be ensured without reducing the optical coupling efficiency so much.

In this embodiment, the shape of the aperture with the second wavelength is made linear in the diameter direction Dr and circular in the tangential direction Dt (hereinafter, this shape will be called “I-cut”). For example, an elliptical aperture can be considered other than this I-cut as the shape in which the numerical aperture NA2r in the diameter direction Dr smaller than the numerical aperture NA2t in the tangential direction Dt.

Both of the I-cut aperture and the elliptical aperture can be used as the shape of the aperture of the aperture diaphragm 22 under the conditions of (3) to (5).

However, comparing with the elliptical aperture, the I-cut aperture has the advantage of excellency in matching property with the laser intensity distribution, namely, in easiness of positioning of the beam center of the laser light and the center of the aperture.

Namely, comparing with the elliptical aperture, the I-cut aperture is small in the intensity variation of the beam spot SP when a deviation exists between the beam center of the laser light and the center of the aperture. As a result, when the objective lens L2 is driven, for example, when the beam spot SP is moved to cross the track T of the optical disc D for track jump, the I-cut aperture has less variation in the light intensity distribution of the beam spot SP than the elliptical aperture. This means that the signal outputted from the photodiode PD becomes more stable in track jump or the like.

The shape of the aperture of the aperture diaphragm 22 can be changed according to the first and the second wavelengths by using a mechanical mechanism. For example, it can be changed by preparing two aperture diaphragms, and replacing the aperture diaphragms corresponding to change-over of the wavelength of the laser light emitted from the laser diode LD.

Besides this, the shape of the aperture of the aperture diaphragm 22 can be changed by using an optical method.

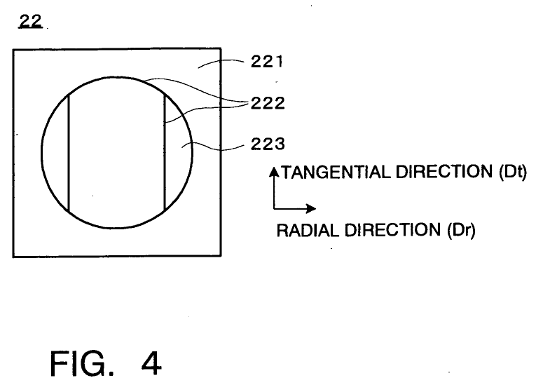

FIG. 4 is a schematic view showing a constitution example of the aperture diaphragm 22.

The aperture diaphragm 22 is constructed by a first member 221 and a second member 222, and has an aperture 223 in an I-cut shape.

The first member 221 is an optical member which does not have light transmission properties for any of the first and the second wavelengths, and the borders from the aperture 223 and the second member 222 are in the circular shape. The second member 222 is an optical member, which has light transmission properties for the first wavelength and does not have the light transmission properties for the second wavelength, and the aperture 223 becomes the aperture as it is.

The second member 222 can stop the passage of the light of the second wavelength by absorbing or reflecting the light. For example, a filter with wavelength selection properties, which transmits the light of the first wavelength and absorbs the light of the second wavelength, can be used for the second member 222. A hologram which transmits the light of the first wavelength and diffracts the light of the second wavelength can be used for the second member 222.

The laser light of the first wavelength does not pass through the first member 221, but passes through the second member 222, and therefore the aperture seen from the first wavelength is the circular shape including both of the aperture 223 and the border from the second member 222. The laser light of the second wavelength does not passes through both the first member 221 and the second member 222, and therefore the aperture seen from the second wavelength is in the I-cut shape which is the shape of the aperture 223 itself.

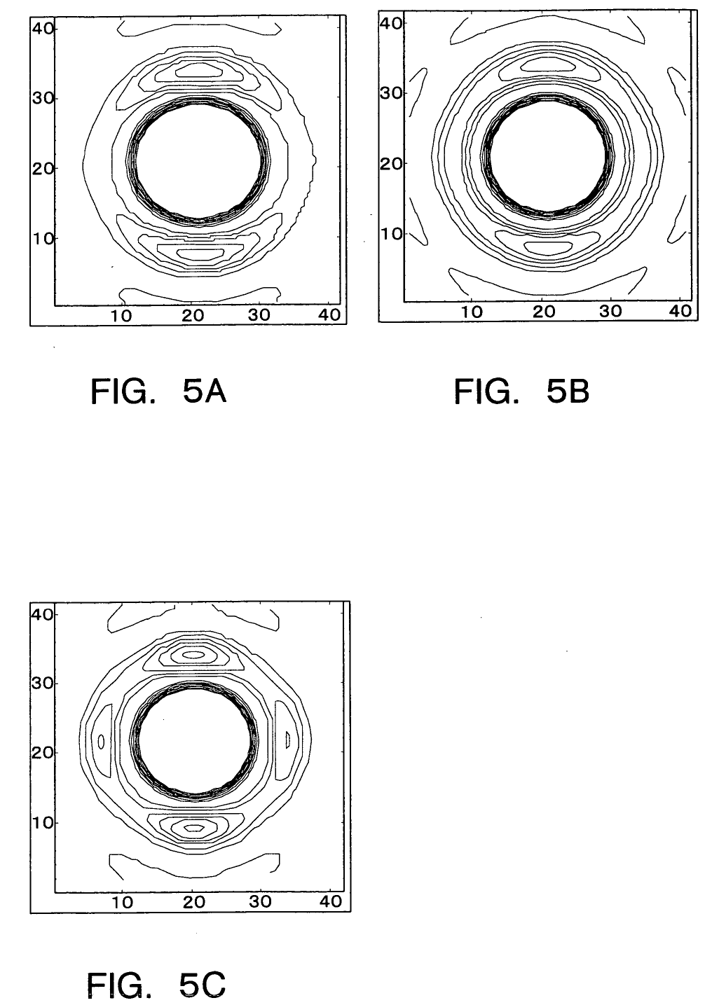

FIGS. 5A, 5B and 5C show the effect of the aperture diaphragm 22 by simulation, and express the intensity distribution of the light of the beam spot by the contour lines (more accurately, isointensity lines). The lateral direction in FIGS. 5A, 5B and 5C is the diameter direction Dr and the vertical direction is the tangential direction Dt.

The respective FIGS. 5A to 5C correspond to the following conditions (A), (B) and (C).
(A) The shape of the aperture: circular, magnifying power of the optical system: 4.0 power, the numerical aperture NA(A): 0.50
(B) The shape of the aperture: circular, magnifying power of the optical system: 6.9 power, the numerical aperture NA(B): 0.51
(C) The shape of the aperture: I-cut, magnifying power of the optical system: 6.9 power, the numerical aperture NAt(C) in the tangential direction Dt: 0.51, the numerical aperture NAr(C) in the radial direction Dr: 0.45

The beam spot diameters Lt in the tangential direction, the beam spot diameters Lr in the radial direction, and the difference (Lr-Lt) in the results of the simulations of the conditions (A), (B) and (C) are as follows.
(A) Lt(A): 1309 nm, Lr(A): 1465 nm, (Lr-Lt) (A): 156 nm
(B) Lt(B): 1281 nm, Lr(B): 1329 nm, (Lr-Lt) (B): 48 nm
(C) Lt(C): 1281 nm, Lr(C): 1389 nm, (Lr-Lt) (C): 108 nm

The condition (A) is for the design corresponding to an ordinary CD, and since the magnifying power of the optical system is small, the spot diameters Lr and Lt are larger than those of the conditions (B) and (C).

Reflecting the intensity distribution of the emission light from the laser diode LD, the spot diameter Lr in the radial direction is larger than the spot diameter Lt in the tangential direction. Since the laser diode LD is an edge-emitting type, the section of the beam of the laser light emitted from the laser diode LD is not circular, but is rather in an oblong shape as an elliptical shape. The major axis of this ellipse is made to correspond to the radial direction Dr of the optical disc D, and therefore the spot diameter Lr in the radial direction is larger than the spot diameter Lt in the tangential direction.

The condition (B) is the design corresponding to an ordinary. DVD, and since the magnification of the optical system is larger than the condition (A), the spot diameters Lt and Lr are smaller than those in the case of the condition (A).

Reflecting the intensity distribution of the emitted light from the laser diode LD, the spot diameter Lr in the radial direction is larger than the spot diameter Lt in the tangential direction, as in the condition (A).

However, the influence of this is limited as compared with the condition (A) because the magnifying power is large (as a result, the influence of diffraction becomes large), and the like.

The condition (C) is for the design considering recording and reproduction of a CD in the optical system commonly used for an ordinary DVD. Therefore, the magnifying power of the optical system is designed to be the same as the condition (B).

Reflecting that both the magnifying power of the optical system and the numerical aperture NAt in the tangential direction Dt are the same as those in the condition (B), the spot diameter Lt in the tangential direction is almost the same as that in the case of the condition (B).

Reflecting that the numerical aperture in the radial direction Dr is smaller than that in the case of the condition (B), the spot diameter Lr in the radial direction is enlarged more than that in the case of the condition (B).

As described above, comparing the conditions (B) and (C), it is found out that the same optical system is set for the DVD and CD (the optical magnifying power is approximately the same) and the numerical aperture in the radial direction is made smaller than the numerical aperture in the tangential direction in the CD, whereby the spot diameter Lr in the radial direction can be enlarged. In this case, the numerical aperture in the tangential direction is kept, and therefore as compared with the case in which the numerical apertures are made small in both the radial direction and tangential direction, reduction in the optical coupling efficiency (utilizing efficiency of light) is limited.

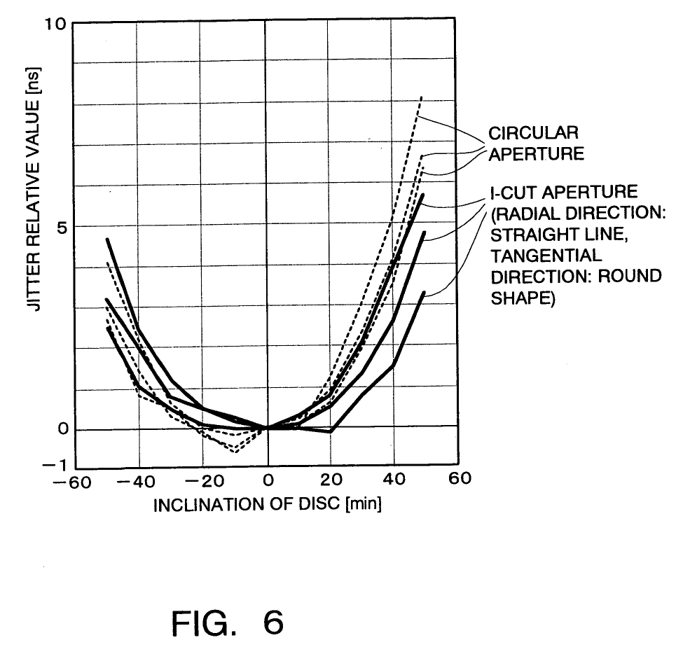

FIG. 6 is a graph showing the correspondence of the skew of the CD (optical disc D) and jitter when the CD is reproduced by using the aperture diaphragm 22 with the I-cut aperture and the round aperture.

The horizontal axis of the graph shows the skew of the CD (unit: min), and the vertical axis shows the relative value of the jitter (the difference in jitter from the case without skew in the CD). The graph of the solid line is of the I-cut aperture and that of the broken line is of the circular aperture.

In FIG. 6, three lines are expressed for each of the I-cut aperture and the circular aperture. This is because three samples of the aperture diaphragm 22 were produced for each of the I-cut aperture and the round aperture and the experiment was conducted.

From FIG. 6, it is found out that the variation in jitter is more suppressed with respect to the skew of the CD in the I-cut aperture.

As for the amount of jitter in the case without a skew in the CD, the result which is not inferior to the case with the circular aperture was obtained in the case of the I-cut.

The above result can be explained as follows.

When there is no skew in the CD, the amount of jitter is approximately the same in the I-cut aperture and the circular aperture corresponding to that the spot diameter Lt in the tangential direction Dt is set to be the same in the I-cut aperture and the round aperture.

When there is a skew in the CD, the variation of jitter in the I-cut aperture is smaller than the variation in jitter in the circular aperture due to that the spot diameter Lr in the radial direction Dr in the I-cut aperture is larger than the spot diameter Lr in the radial direction in the circular aperture. This is because signal generation by the photodiode PD can be performed stably (margin is widened) if the spot diameter Lr in the radial direction is large. This is because the signal component included in the reflection light from the optical disc D, which passes through the aperture diaphragm 22, becomes large when the spot diameter Lr in the radial direction is large.

(The other embodiments)

The embodiment of the present invention is not limited to the above-described embodiment, and can be enlarged and changed, and the enlarged and changed embodiments are included in the technical scope of the present invention.

1. An optical disc reproducing device, comprising:
a first light source configured to emit laser light of a first wavelength;
a second light source configured to emit laser light of a second wavelength that is longer than the first wavelength;
an objective lens configured to condense the laser light emitted from said first and second light sources on an optical disc; and
an aperture diaphragm disposed between said first and second light sources and said objective lens, in which an aperture differs for the first and second wavelengths, and the aperture in the radial direction of the optical disc is smaller than the aperture in a circumferential direction at the second wavelength.

2. The optical disc reproducing device according to claim 1, wherein a shape of the aperture of the aperture diaphragm at the first wavelength is a circular shape.

3. The optical disc reproducing device according to claim 1, wherein a shape of the aperture of the aperture diaphragm at the second wavelength is an elliptical shape.

4. The optical disc reproducing device according to claim 1, wherein the shape of the aperture of the aperture diaphragm at the second wavelength is a linear shape in the radial direction of the optical disc, and is a circular shape in the circumferential direction.

5. The optical disc reproducing device according to claim 1, wherein said aperture diaphragm includes a member which differs in transmittance for the first and the second wavelengths.

6. The optical disc reproducing device according to claim 1, wherein said first and second light sources are in close vicinity to each other.

7. The optical disc reproducing device according to claim 1, wherein said first and second light sources are integrally constructed.

8. The optical disc reproducing device according to claim 1, wherein the first and the second wavelengths are approximately 650 nm and approximately 780 nm, respectively.

9. An optical disc reproducing method, comprising:
emitting laser light of one of a first wavelength and a second wavelength longer than the first wavelength from a light source;
passing the emitted laser light through an aperture diaphragm in which an aperture differs for the first and the second wavelengths, and the aperture in a radial direction of the optical disc is smaller than the aperture in a circumferential direction; and
condensing the passed laser light onto an optical disc.

10. The optical disc device according to claim 1, wherein the shape of the aperture of the aperture diaphragm at the first wavelength is a circular shape.

11. The optical disc reproducing method according to claim 9, wherein a shape of the aperture of the aperture diaphragm at the second wavelength is an elliptical shape.

12. The optical disc reproducing method according to claim 9, wherein a shape of the aperture of the aperture diaphragm at the second wavelength is a linear shape in the radial direction of the optical disc, and is a circular shape in the circumferential direction.

13. The optical disc reproducing method according to claim 9, wherein the aperture diaphragm includes a member which differs in transmittance for the first and the second wavelengths.

14. The optical disc reproducing method according to claim 9, wherein emitting points of the first and the second laser light are in close vicinity to each other.

15. The optical disc reproducing method according to claim 9, wherein the first and the second wavelengths are approximately 650 nm and approximately 780 nm, respectively.
